(19) United States
(12) Patent Application Publication
(10) Pub. No.: US 2026/0239100 A1
(43) Pub. Date: Aug. 13, 2026

(54) BSR PRIORITIZATION FOR MODE 1 WIRELESS TRANSMIT/RECEIVE UNIT(S) IN MULTIPATH

(71) Applicant: InterDigital Patent Holdings, Inc., Wilmington, DE (US)

(72) Inventors: Martino Freda, Laval (CA); Tuong Hoang, Montreal (CA); Oumer Teyeb, Montreal (CA); Ananth Kini, Conshohocken, PA (US)

(73) Assignee: InterDigital Patent Holdings, Inc., Wilmington, DE (US)

(21) Appl. No.: 19/155,490

(22) PCT Filed: Feb. 14, 2024
(86) PCT No.: PCT/US2024/015743

§ 371 Date: Aug. 11, 2025

Related U.S. Application Data
(60) Provisional application No. 63/445,327, filed on Feb. 14, 2023.

(51) Int. Cl. H04W 28/02; H04W 72/25

(52) U.S. Cl. CPC H04W 28/0278; H04W 72/25

(57) ABSTRACT

A WTRU may be configured to receive a bearer configuration information. For example, the bearer configuration information may comprise at least one of: a configuration for a first bearer that is associated with a direct path, a configuration for a second bearer that is associated with an indirect path, and/or a configuration for a third bearer that is associated with the direct path and the indirect path. The WTRU may receive data at the third bearer. The WTRU may determine a BSR type associated with the received data based at least on a primary path configured for the WTRU. For example, if the primary path configured for the WTRU is the direct path, BSR type may be determined to be the Uu BSR. If, for example, the primary path configured for the WTRU is the indirect path, the BSR type may be determined to be a SL BSR.

### CROSS-REFERENCE TO RELATED APPLICATIONS

This application claims the benefit of U.S. Provisional Patent Application No. 63/445,327 filed on Feb. 14, 2023, the entire contents of which are incorporated herein by reference.

### BACKGROUND

A multi-path relay may be utilized for WTRU aggregation. For example, a WTRU may be connected to the network via direct path and via another WTRU using a WTRU-WTRU interconnection (e.g., a non-standardized connection). WTRU aggregation may be used to provide applications requiring high UL bitrates. For example, WTRU aggregation may be used if WTRU(s) are limited by UL WTRU transmission power to achieve a required bitrate (e.g., at the edge of a cell). Also, or alternatively, WTRU aggregation may improve reliability and stability, and reduce delay of services. For example, if the channel condition of a terminal is deteriorating, another terminal may be used to make up for the traffic performance unsteadiness caused by channel condition variation.

Multipath may be used to enhance reliability and/or throughput. For example, multipath configurations may be used to enhance reliability and/or throughput by switching among or utilizing the multiple paths simultaneously. A WTRU may be connected to a gNB using a direct path and an indirect path (e.g., the same gNB), for example, via a Layer-2 WTRU-to-Network relay, or via another WTRU (e.g., where the WTRU-WTRU inter-connection is assumed to be ideal).

### SUMMARY

A wireless transmit receive unit (WTRU) may be configured to receive bearer configuration information. In examples, the bearer configuration information may comprise at least one of: a configuration for a first bearer that is associated with a direct path, a configuration for a second bearer that is associated with an indirect path, and a configuration for a third bearer that is associated with the direct path and the indirect path. The WTRU may receive data via the first bearer and the third bearer. The WTRU may generate a Uu buffer status report (BSR) in response to data received via the first bearer. The WTRU may generate a sidelink (SL) BSR in response to data received via the third bearer. The WTRU may determine a priority associated with the SL BSR, and a priority associated with the Uu BSR. In examples, the priority associated with the SL BSR may be greater than the priority associated with the Uu BSR. The WTRU may send a transmission comprising the SL BSR in a first uplink (UL) grant.

The transmission comprising the SL BSR may be sent on a primary path configured for the WTRU. The WTRU may also receive data via the second bearer. The WTRU may generate a SL BSR for the data received at the second bearer. The WTRU may determine a priority associated with the SL BSR generated in response to data received at the second bearer. In examples, the WTRU may determine a priority for the second and third bearer based on any of: a quality of service (QoS), an associated cell ID, a priority threshold, or an indication received in the configuration for the first or second bearer. The data received via the first bearer and the data received via the third bearer may be associated with a quality of service (QoS). The WTRU may determine a priority for the SL BSR based on the QoS.

The received data via the first bearer and the data received via the third bearer may be associated with a latency threshold. The WTRU may determine a priority for the SL BSR based on the latency threshold. The WTRU may also send a second transmission comprising the Uu BSR in a second UL grant, which may be after the first UL grant. The WTRU may also determine a priority for the SL BSR based on a cell identifier (ID) associated with the direct path and a cell ID associated with the indirect path.

The WTRU may also receive data via the second bearer. The WTRU may generate a SL BSR for the data received at the second bearer. The WTRU may determine a prioritized SL logical control channel (LCH) to report the SL BSR. In examples, the SL LCH may be determined to be prioritized if the SL BSR corresponding to the second bearer path has a priority larger than a threshold.

The WTRU may also generate a Uu BSR in response to data received via the third bearer. The WTRU may determine a priority associated with the Uu BSR generated in response to data received via the third bearer. In examples, the priority associated with the Uu BSR generated in response to data received via the third bearer may be greater than the priority associated with the Uu BSR generated in response to data received via the first bearer. The WTRU may determine a prioritized SL LCH to report the SL BSR. In examples, the SL LCH may be determined to be prioritized based on the priority of the Uu BSR generated in response to data received via the third bearer being higher than the priority associated with the Uu BSR generated in response to data received via the first bearer. The WTRU may be a remote WTRU configured in multipath mode 1 for SL transmissions.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2A illustrates an example associated with a user plane protocol stack for layer 2 (L2) WTRU-to-network relay.

FIG. 2B illustrates an example associated with a control plane protocol stack for L2 WTRU-to-network relay.

FIG. 3 illustrates an example associated with a split bearer.

FIG. 4 illustrates an example associated with a protocol stack for carrier aggregation (CA).

FIG. 5 illustrates an example associated with a protocol stack for multipath.

### DETAILED DESCRIPTION

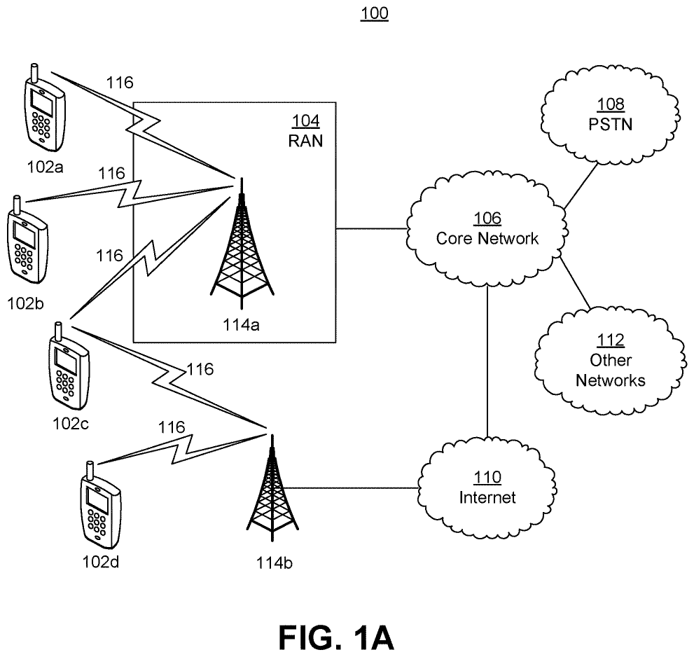

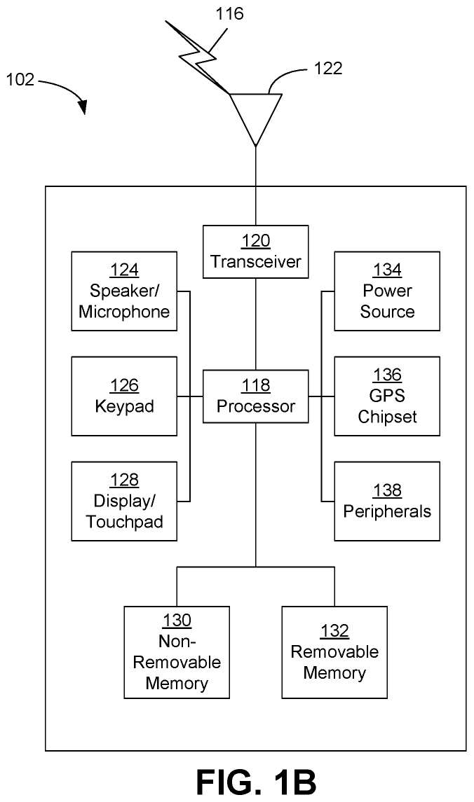

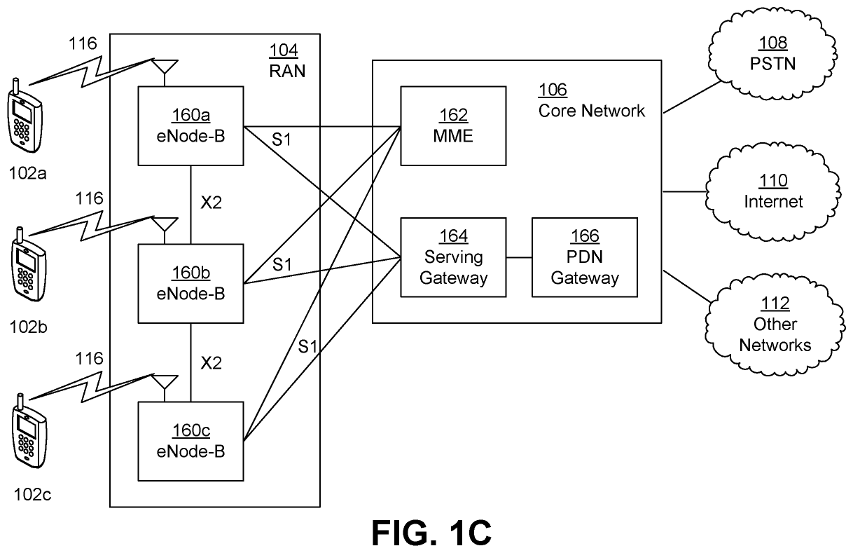

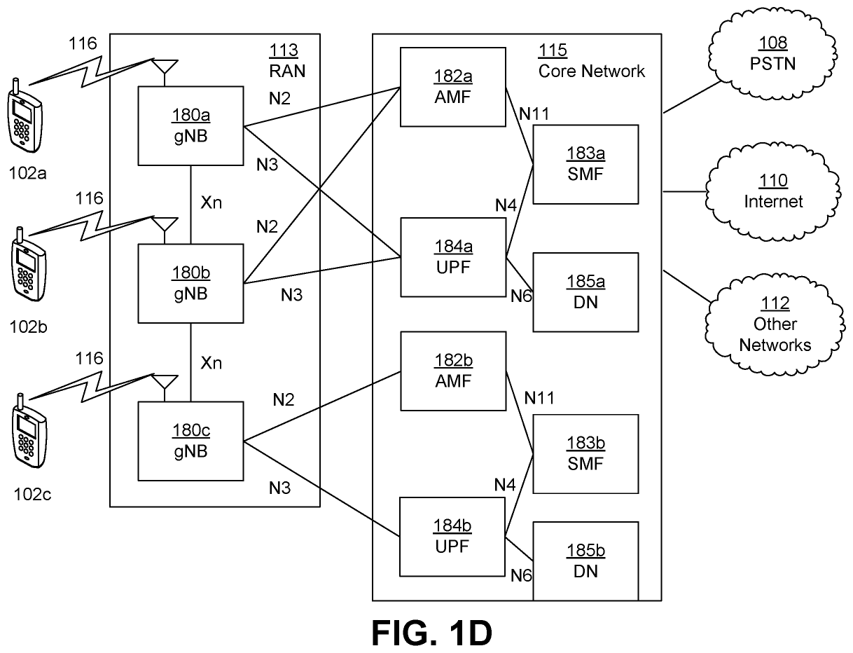

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUS 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

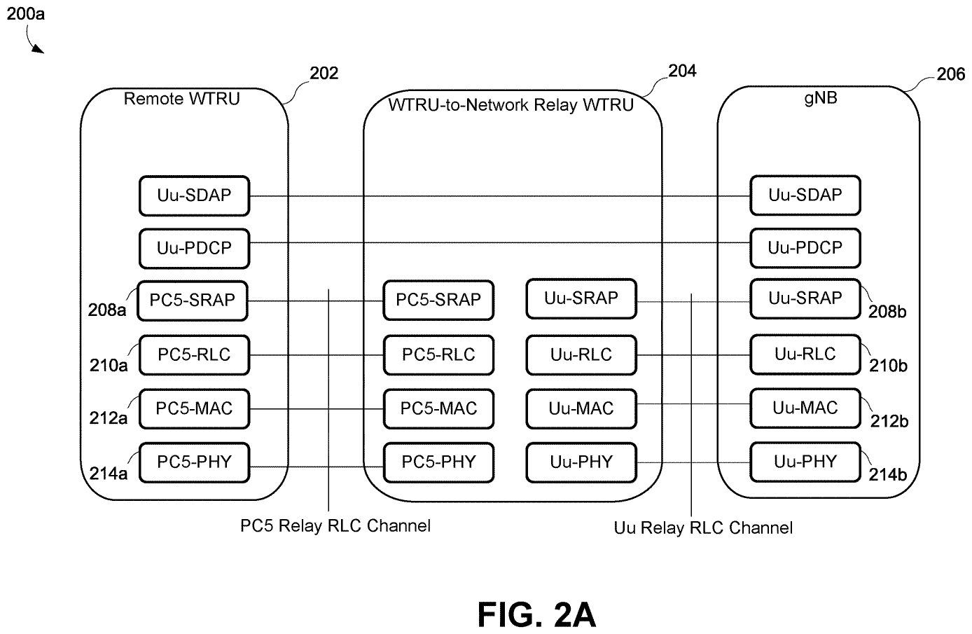

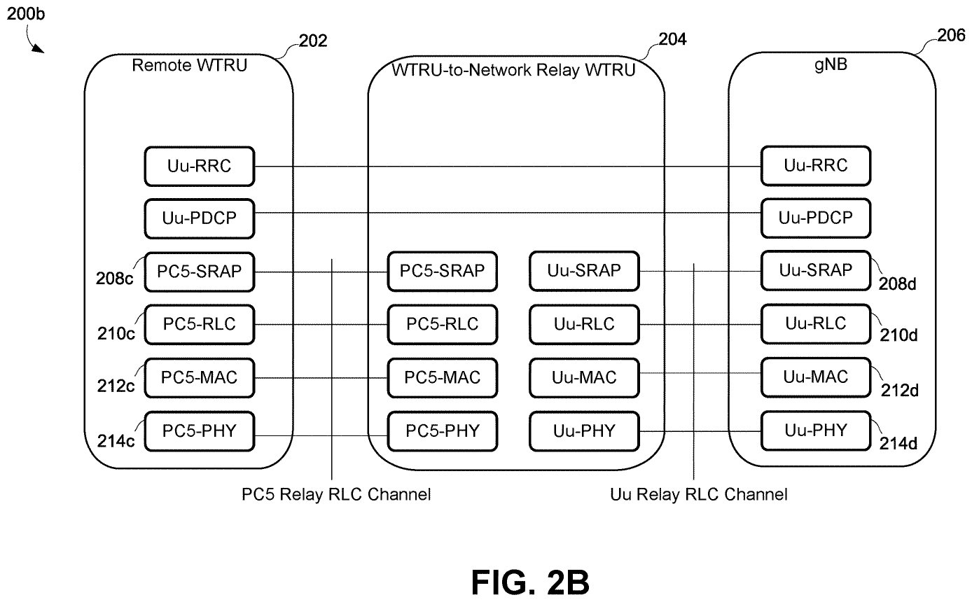

An example protocol stack for the user plane 200a associated with a layer 2 (L2) WTRU to network relay architecture is illustrated in FIG. 2A. An example protocol stack for the control plane 200b associated with an L2 WTRU to network relay architecture is illustrated in FIG. 2B.

As shown in FIG. 2A, a PC5 sidelink relay adaptation protocol (SRAP) sublayers 208a, 208b may be placed above a PC5 radio link control (RLC) sublayer 210a, 210b for the user plane (UP). As shown in FIG. 2B, a Uu sidelink relay adaptation protocol (SRAP) sublayer 208c, 208d may be placed above a Uu RLC sublayer 210c, 210c for the control plane (CP). Uu services, e.g., including data adaptation protocol (SDAP), packet data convergence protocol (PDCP), and/or radio resource control (RRC), may be terminated between a remote WTRU 202 and a network node 206 (e.g., base station, gNB, etc.). The SRAP sublayers 208a, 208b, 208c, 208d, RLC sublayers 210a, 210b, 210c, 210d, MAC layer 212a, 212b, 212c, 212d, and/or physical (PHY) layers 214a, 214b, 214c, 214d may be terminated, for example, in each hop (e.g., the link between a Remote WTRU and the Relay WTRU and/or the link between Relay WTRU and the gNB).

For a L2 WTRU-to-network relay 204, the SRAP sublayer 208a, 208c over PC5 hop may be used for bearer mapping (e.g., may only be used for bearer mapping). The SRAP sublayer 208a, 208c may not be present over a PC5 hop, for example, for relaying the remote WTRU's message on the broadcast control channel (BCCH) and/or the paging control channel (PCCH). For a remote WTRU messages on SRB0, for example, a SRAP header may not be present over a PC5 hop. The SRAP header may be present over Uu hop (e.g., for the DL and/or the UL).

A WTRU may perform resource allocation and/or resource selection in mode 1 and/or mode 2. For example, a sidelink (SL) WTRU may be configured to operate in mode 1 or mode 2. In mode 1, the WTRU may be scheduled on SL by the network (e.g., DCI scheduling SL grants). In mode 2, the WTRU may perform resource (re)selection to schedule SL resources.

Mode 2 resource selection may be associated with the use of sensing. A WTRU that supports sensing may use the results of sensing to select a set of resources for transmission. In examples, the sensing results utilized by the WTRU may be an indication of SL control information (SCI) transmissions over a period of time which may be forward booking resources. Resource selection may include determining a set of available resources, (e.g., based on the sensing results) and comparing the observed SCIs reference signal received power (RSRP) with a threshold. For example, the threshold may be based on a priority of the transmission to be made during the sensing and/or the transmission announced by the other SCI. If a certain percentage of resources is determined to be available, a WTRU may select (e.g., randomly select) resources to be used for transmission (e.g., for a single transmission or for multiple periodic transmissions announced by a forward booking indication in SCI). When insufficient resources are available to perform selection (e.g., random selection), the WTRU may increase its threshold for availability by an amount (e.g., 3 dB), for example, until a sufficient amount of resources are deemed as available.

Mode 2 resource selection may be associated with congestion control. Mode 2 resource selection may be used to avoid increased network congestion. For example, a WTRU may measure the channel busy ratio (CBR) and may be configured for transmission based on the CBR (e.g., max number of retransmission, MCS, maximum number of subchannels, etc.), which may be used to avoid increased network congestion. Congestion parameters may also, or alternatively, be based on the priority of a transmission (e.g., higher priority transmissions are less affected by congestion control limitations).

A WTRU may send buffer status reports (BSRs) for the SL (e.g., a SL BSR) and/or for the Uu (e.g., a Uu BSR). For example, a WTRU may be triggered to send a SL BSR and/or Uu BSR. In examples, the triggers for a WTRU to send Uu BSR may be similar to the triggers for a WTRU to send a SL BSR (e.g., regular BSR).

A WTRU may be triggered to send a BSR if UL data (e.g., for a logical channel that belongs to a logical channel group (LCG)) becomes available to the MAC entity. For example, the WTRU may be triggered to send a BSR if the UL data belongs to a logical channel (LCH) with higher priority than the priority of any LCH containing available UL data. Such a BSR may also, or alternatively, be referred to herein as a regular BSR.

A WTRU may be triggered to send a BSR if a number of padding bits (e.g., of allocated UL resources) is equal to and/or larger than the size of the Buffer Status Report MAC CE plus its sub-header. Such a BSR may be referred to herein as a padding BSR.

A WTRU may be triggered to send a BSR if a timer (e.g., a retxBSR-Timer) expires, and at least one of the logical channels that belong to a LCG includes UL data. Such a BSR may be referred to herein as a regular BSR.

A WTRU may be triggered to send a BSR if a periodicBSR-Timer expires, which may be referred to herein as a periodic BSR.

If a regular BSR triggering events occurs for multiple logical channels simultaneously, each logical channel may trigger a (e.g., one) separate regular BSR.

For SL BSR, a prioritization mechanism may be used to address the size of the SL-BSR (e.g., as a result of the inclusion of the destination ID). For example, a WTRU may transmit a prioritized SL-BSR and/or a normal SL-BSR. A prioritized SL-BSR, when transmitted, may be included in a grant with a higher priority than a Uu BSR. A normal SL-BSR may be transmitted with a lower priority than a Uu BSR. A WTRU may determine whether a SL BSR is prioritized, for example, based on whether the SL LCH for which buffer status is being reported are themselves prioritized. Prioritized SL logical channels may include logical channels where the SL-LCH priority is above a threshold, and/or there is no Uu LCH with a Uu LCH priority above another threshold.

The order in which SL-BSRs are included, as compared to other MAC CEs, may be prioritized. In examples, logical channels may be prioritized in the following order (e.g., highest priority listed first): (1) MAC CE for C-RNTI, or data from UL-CCCH; (2) MAC CE for (enhanced) BFR, or MAC CE for configured grant confirmation, or MAC CE for multiple entry configured grant confirmation; (3) MAC CE for sidelink configured grant confirmation; (4) MAC CE for LBT failure; (5) MAC CE for timing advance report; (6) MAC CE for certain prioritized SL-BSR; (7) MAC CE for (extended) BSR, with exception of BSR included for padding; (8) MAC CE for (enhanced) single entry PHR, or MAC CE for (enhanced) multiple entry PHR; (9) MAC CE for positioning measurement gap activation/deactivation request; (10) MAC CE for the number of desired guard symbols; (11) MAC CE for case-6 timing request; (12) MAC CE for (extended) pre-emptive BSR; (13) MAC CE for SL-BSR, with exception of certain prioritized SL-BSR and SL-BSR included for padding; (14) MAC CE for IAB-MT recommended beam Indication, or MAC CE for desired IAB-MT PSD range, or MAC CE for desired DL Tx power adjustment; (15) data from any logical channel, except data from UL-CCCH; (16) MAC CE for recommended bit rate query; (17) MAC CE for BSR included for padding; and (18) MAC CE for SL-BSR included for padding.

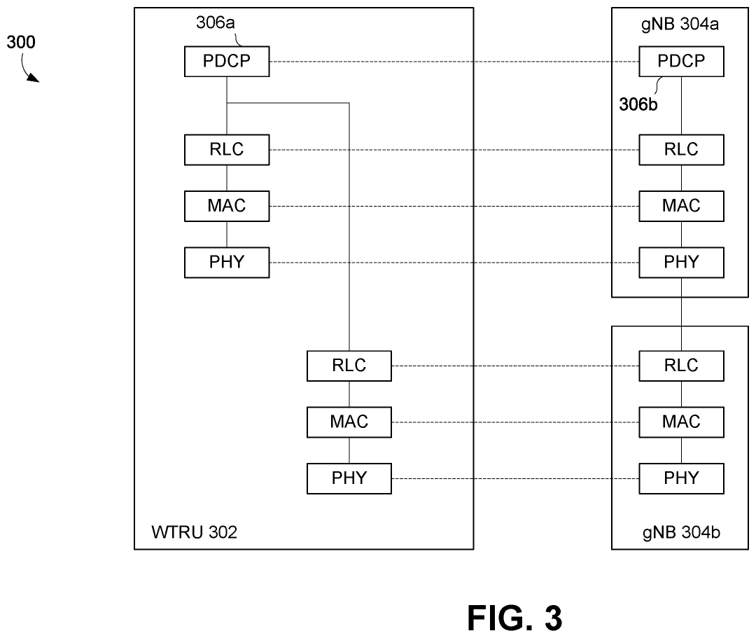

FIG. 3 illustrates an example associated with a split bearer. Split bearers may be used in dual connectivity (DC). Referring to FIG. 3, for example, a WTRU 302 may be served by two nodes, gNB 304a and gNB 304b in DC. Each node may comprise a set of cells, known as the Master Cell Group (MCG) and Secondary Cell Group (SCG). A bearer may be associated with the MCG or the SCG. A bearer may also, or alternatively, be configured to be a split bearer. For split bearers, data may be sent to the MCG and/or the SCG.

The WTRU 302 may have an associated packet data convergence protocol (PDCP) entity 306a (e.g., like any bearer). The peer PDCP entity 306b on the network side may be terminated at the gNBs 304a, 304b (e.g., either the master or the secondary). In the DL, the core network (CN) may send data to the gNB where the PDCP is terminated (e.g., gNB 304a in FIG. 3) and the network. The CN may determine whether to send the data to the WTRU 302 via the link between the gNB 304a and the WTRU 302 or to forward the PDCP PDUs to gNB2 304b (e.g., via Xn interface). The gNB (e.g., the gNB 304a) may send the data to the WTRU (e.g., via the link between the gNB 304a and the WTRU).

In the UL, the WTRU may be configured with a primary path and a secondary path. A threshold (e.g., UL split buffer threshold) may be configured. If the UL buffer size for a given bearer is less than the threshold, the PDCP may push the data to (e.g., only to) the RLC associated with the primary path. However, if the buffer size becomes larger than the threshold, the WTRU may push the data to either the primary path or the secondary path (e.g., left for WTRU to determine).

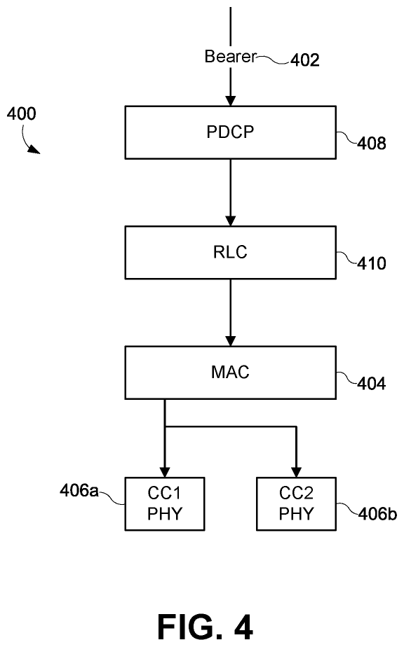

FIG. 4 illustrates an example associated with a protocol stack 400, which may be used for CA. As illustrated in FIG. 4, the protocol stack 400 may include a PDCP layer 408, an RLC layer 410, and a MAC layer 404. In examples, for carrier aggregation (CA), data in a bearer 402 may be transmitted via a carrier (e.g., any carrier). A logical channel at the MAC layer 404 may send data on two (e.g., any two) carriers 406a, 406b in a flexible manner to either carrier (e.g. or be configured with a duplicate logical channel to allow CA duplication with carrier restriction). The PDCP layer 408 may be responsible for implementing security and header compression. The RLC layer 410 may be responsible for segmentation and/or performing automatic retransmission on request (ARQ) for acknowledge mode (AM) bearers.

One or more techniques, which may be implemented to enhance SL relays, may be described herein. For example, multipath may be supported with a relay (e.g., where a remote WTRU is connected to the network via a direct path and an indirect path), which may improve reliability/robustness and/or throughput.

A multi-path relay may be utilized for WTRU aggregation. For example, a WTRU may be connected to the network via a direct path and via another WTRU using a WTRU-WTRU interconnection (e.g., a non-standardized connection). WTRU aggregation may be used to provide applications requiring higher UL bitrates. For example, WTRU aggregation may be used if WTRU(s) are limited by UL WTRU transmission power to achieve a required bitrate (e.g., at the edge of a cell). Also, or alternatively, WTRU aggregation may improve reliability and stability, and reduce delay of services. For example, if the channel condition of a terminal is deteriorating, another terminal may be used to make up for the traffic performance unsteadiness caused by channel condition variation.

Multipath may be used to enhance reliability and/or throughput. For example, multipath configurations may be used to enhance reliability and/or throughput by switching among or utilizing the multiple paths simultaneously. A WTRU may be connected to a gNB using a direct path and an indirect path (e.g., the same gNB), for example, via a Layer-2 WTRU-to-Network relay, or via another WTRU (e.g., where the WTRU-WTRU inter-connection is assumed to be ideal).

In CA, a LCH (e.g., a single LCH) may be multiplexed on one or more carriers (e.g., any of the carriers). Because SL and Uu LCHs may have different configurations, in examples, a single LCH may not be used to achieve the same flexibility of a MAC-based decision between the SL and the Uu. Techniques, methods, and implementations related to sending BSRs for a bearer that can be transmitted on the SL and/or the Uu may be provided. For example, techniques, methods, and implementations for determining if a BSR is to be sent via an SL BSR or a Uu BSR may be described herein.

In examples, the buffer status for SL data may be included in SL BSR, while the buffer status for Uu data may be included in Uu BSR. Techniques for sending BSRs for multipath bearers may be provided. For example, if all the data is included in a single BSR (e.g., Uu BSR), the LCG space may be increased unnecessarily. If the all the data is included in a single BSR, a SL BSR may not be useful, for example, as there may only be a single relay (e.g., the L2 ID in the BSR becomes redundant).

A WTRU may determine (e.g., dynamically select) a BSR type to use for multipath data. A remote WTRU may determine a BSR type (e.g., SL BSR or Uu BSR) to send the buffer status for a Uu bearer related to multipath data. For example, the WTRU may determine the BSR type based on the cell IDs of the direct and indirect path and/or the mapping of the multipath bearer to the two paths.

A WTRU may be configured to receive a bearer configuration information. For example, the bearer configuration information may comprise at least one of: a configuration for a first bearer that is associated with a direct path, a configuration for a second bearer that is associated with an indirect path, and/or a configuration for a third bearer that is associated with the direct path and the indirect path. Each of the first bearer, the second bearer, and the third bearer may be associated with a priority. The WTRU may receive data at least one of the first bearer, the second bearer, or the third bearer. The WTRU may determine a buffer status report (BSR) type based at least on a cell ID associated with the direct path and a cell ID associated with the indirect path. The BSR type may include one of a Uu BSR or a sidelink (SL) BSR. For example, if the cell ID associated with the direct path and the cell ID associated with the indirect path are the same, the BSR type may be the Uu BSR.

The WTRU may also, or alternatively, be configured to determine the BSR type based on one or more other conditions. For example, the received data may be associated with a quality of service (QoS), and the BSR type may be further determined based on the QoS. In examples, the WTRU may be configured to communicate with a remote WTRU via an interface (e.g., a SL interface or a direct interface), and the BSR type may be further determined based on the configured interface.

A remote WTRU in multipath may be configured in mode 1 for SL transmissions. One or more of the following may apply. The remote WTRU may be configured with at least one Uu bearer that is sent over a direct (e.g., Uu) path. The remote WTRU may be configured with at least one Uu bearer that is sent over an indirect (e.g., relayed) path. The remote WTRU may be configured with at least one Uu bearer that is sent over a direct path and an indirect path. Data may arrive at the WTRU for UL transmission at one of the bearers. If the cell ID of remote WTRU's direct path and the cell ID of the relay WTRU are the same, the remote WTRU may send the buffer status for the bearer on the Uu BSR. If the cell ID of the remote WTRU and the relay WTRU are different, the remote WTRU may send the buffer status for a Uu bearer configured on the direct path in Uu BSR. Also, or alternatively, if the cell ID of the remote WTRU and the relay WTRU are different, the remote WTRU may send the buffer status for a Uu bearer configured on the indirect path in SL BSR. Also, or alternatively, if the cell ID of the remote WTRU and the relay WTRU are different, the remote WTRU may send the buffer status for a Uu bearer configured on both paths in the BSR (Uu or SL) configured by the network.

A WTRU may use a BSR for flexible/relayed bearers. One or more of the following may apply. A remote WTRU may send a BSR related to a flexible bearer (e.g., a bearer configured over both direct and indirect path) and/or relayed bearer (e.g., a bearer configured over the relayed path) via a flexible BSR MAC CE (e.g., a BSR MAC CE associated with flexible bearers). The flexible BSR MAC CE may be associated with a priority. For example, the priority associated with the flexible BSR MAC CE may be determined based on whether the BSR reports data for a flexible bearer or for a relayed bearer (e.g., only a relayed bearer).

A WTRU may be configured to receive a bearer configuration information. For example, the bearer configuration information may comprise at least one of: a configuration for a first bearer that is associated with a direct path, a configuration for a second bearer that is associated with an indirect path, and/or a configuration for a third bearer that is associated with the direct path and the indirect path. Each of the first bearer, the second bearer, and the third bearer may be associated with a priority. The WTRU may receive data at one of the second bearer or the third bearer. The WTRU may generate a BSR MAC CE in response to the received data. For example, the flexible BSR MAC CE may include an indication of a LCG and an indication of the buffer size. If, for example, the data is received at the second bearer, the indication of the LCG may comprise an LCG identifier associated with the second bearer. If, for example, the data is received at the third bearer, and wherein the indication of the LCG comprising an LCG identifier associated with the third bearer. Also, or alternatively, the flexible BSR MAC CE may further include a destination identifier. The destination identifier (e.g., included in the flexible BSR MAC CE) may indicate a destination where the WTRU may send the received data. The WTRU may determine a priority associated with the BSR MAC.

The WTRU may also receive data at the first bearer. The WTRU may generate a second BSR in response to the data received at the first bearer. For example, the second BSR may be associated with a priority. The WTRU may compare the priority of the second BSR with the priority associated with the flexible BSR MAC CE. The WTRU may determine an order associated with sending the flexible BSR MAC CE and the second BSR based on the comparison.

A remote WTRU in multipath may be configured in mode 1 for SL transmissions. One or more of the following may apply. The remote WTRU may be configured with at least one Uu bearer that is sent over the direct (e.g., Uu) path. The remote WTRU may be configured with at least one Uu bearer that is sent over the indirect (e.g., relayed) path. The remote WTRU may be configured with at least one Uu bearer that is sent over the direct path and the indirect path. If data arrives at the WTRU for UL transmission on a bearer configured on (e.g., only on) the direct path, the remote WTRU may report the buffer status for the data in a Uu BSR. If data arrives at the WTRU for UL transmission for a bearer configured on the indirect path or on both paths, the remote WTRU may report the buffer status for the data in an updated BSR. For example, the remote WTRU may include the LCG ID configured for the Uu LCH of the flexible bearer and/or the LCG ID of the SL LCH of the relayed bearer in the updated BSR. Also, or alternatively, the WTRU may include the LCG ID configured for the Uu LCH of the flexible bearer and/or the LCG ID of the SL LCH of the relayed bearer and a relay/L2 destination ID (e.g., for future proof) in the updated BSR. The remote WTRU may determine the relative priority of the updated BSR and the Uu BSR. For example, if the BSR includes a buffer status for a flexible bearer, the remote WTRU may treat the BSR similar to a Uu BSR and/or compare the highest priority Uu LCH of the flexible bearer with the highest priority Uu LCH in the normal Uu BSR (e.g., taking the highest priority), for example, to determine the priority of the updated BSR compared with the normal Uu BSR. If the BSR includes a buffer status for an indirect bearer (e.g., only an indirect bearer), the remote WTRU may treat the BSR similar to a SL BSR and/or compare the priority of the SL LCH with the SL threshold to determine the priority of the update BSR compared with the normal Uu BSR (e.g., if higher than the threshold, prioritize the updated BSR over the Uu BSR). If, for example, the WTRU transmits a Uu BSR, SL BSR, and updated BSR, the Uu BSR, SL BSR, and updated BSR may be included in a grant in a given order. For example, the order may be determined based on the respective priority of the Uu BSR, SL BSR, and updated BSR.

For multipath, a SL BSR or Uu BSR may be prioritized. For example, a remote WTRU may prioritize an SL BSR over a Uu BSR, e.g., based on whether SL BSR includes data from a flexible bearer.

A remote WTRU in multipath may be configured in mode 1 for SL transmissions. One or more of the following may apply. The remote WTRU may be configured with at least one Uu bearer that is sent over the direct (e.g., Uu) path. The remote WTRU may be configured with at least one Uu bearer that is sent over the indirect (e.g., relayed) path. The remote WTRU may be configured with at least one Uu bearer that is sent over the direct and indirect path. If, for example, data arrives at the WTRU for UL transmission on a bearer on the direct path, the remote WTRU may report the buffer status for the data in a Uu BSR. If, for example, data arrives at the WTRU for UL transmission on a bearer on the indirect path, the remote WTRU may report the buffer status for the data in a SL BSR. If, for example, data arrives at the WTRU for UL transmissions on a bearer on both paths, the remote WTRU may report the buffer status to the BSR (e.g., Uu or SL), for example, based on the configured primary path.

The remote WTRU may determine the prioritized SL LCH to report in the prioritized SL BSR. One or more of the following may apply. The remote WTRU may determine to prioritize the SL LCH if, for example, the SL LCH corresponding to a bearer on the indirect path has a priority larger than a threshold. The remote WTRU may prioritize a SL LCH if, for example, the SL LCH corresponds to a bearer on the direct and the indirect path and/or the Uu LCH priority associated with the bearer is higher than the highest Uu LCH priority in the Uu BSR. If the SL BSR is prioritized, the SL BSR may be included in a grant, e.g., before the Uu BSR.

In DC, for example, the PDCP may determine whether to push data in a MCG or a SCG, for example, based on the buffer status. The WTRU may determine the amount of data to push to a given RLC channel. In multipath for a remote WTRU, for example, data may be dynamically routed to either path, e.g., depending on availability of grants (e.g., similar to CA).

Certain issues may arise in applying a CA model to multipath. For example, difficulties in defining a logical channel where data available for such logical channel is dynamically transmitted to the SL (e.g., relayed path) path or Uu (e.g., direct path) may arise, e.g., since a logical channel in Uu and a logical channel on sidelink may be associated with different RRC configurations.

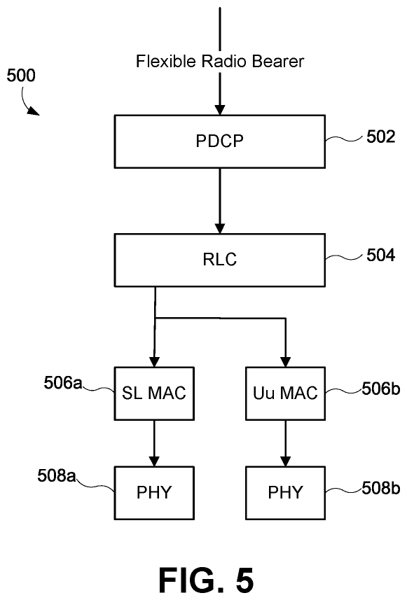

An example protocol stack 500, which may be used for multipath is illustrated in FIG. 5. As illustrated in FIG. 5, the protocol stack 500 may include a PDCP layer 502, an RLC layer 504, an SL MAC layer 506a, and a Uu MAC layer 506b. The protocol stack 500 may also include PHY layers 508a, 508b. PHY layer 508a may be associated with the SL. PHY layer 508b may be associated with the Uu interface. The PDCP layer 502 may be responsible for implementing security and header compression. The RLC layer 504 may be responsible for segmentation and/or performing automatic retransmission on request (ARQ) for acknowledge mode (AM) bearers. The RLC entity 504 may be capable of dynamically sending data via a SL path or a Uu path. The (e.g., a single) RLC entity 504 may be configured with one or more (e.g., two) logical channels. A SL logical channel may be used for data transmissions via the indirect path, and a Uu logical channel may be used for data transmissions via the direct path. The SL logical channel may comprise a SL MAC layer 506a and a physical layer 508a. The Uu logical channel 506b 508b may comprise a Uu MAC layer 506b and a physical layer 508b. The Uu logical channel may be configured to perform like certain (e.g., legacy) Uu logical channels. The SL logical channel 506a 508a may be configured to perform like SL logical channels. Duplication of PDUs on the two paths may also be supported, for example, by having the RLC 502 entity transmit a PDU to the direct and indirect paths and both logical channels transmit the data on their respective interface (Uu and SL).

As described herein, a split data radio bearer (DRB) may be mapped to two logical channels (e.g., which may not be the case for CA, where a single logical channel may be assumed). One or more of the following may apply. Uu RBs (e.g., which may be used for stringent latency) may be configured to transmit data via the Uu interface. Sidelink RBs (e.g., which may be used for long latency data) may be configured to transmit data via the sidelink interface. Flexible RBs (e.g., which may be used for medium latency data and high reliability) may be configured to transmit data via either the Uu interface or the sidelink interface, for example, based on certain conditions.

Although the techniques described herein are used with flexible radio bearers (e.g., as flexible radio bearers may dynamically send data over either path without RRC reconfiguration, they may also, or alternatively, be applied to the any other suitable scenario (e.g., Uu RBs and the sidelink RBs). For example, techniques described herein may be used to determine whether to send data to MCG or SCG in DC. For example, techniques described herein may be used to determine whether to send data to one carrier or another. For example, techniques described herein may be used to decide whether to send data to a SL link or a non-3GPP link (e.g., bluetooth).

A WTRU may determine whether to send multipath data in a Uu BSR or a SL BSR, for example, based on the bearer type. In certain scenarios, a WTRU may determine whether to send the buffer status for a bearer in Uu BSR or SL BSR based on the type of bearer. For example, for direct bearers (e.g., bearers configured only over the Uu path), the WTRU may send buffer status for the bearers in Uu BSR. For example, for indirect bearers (e.g., bearers configured only over the SL path), the WTRU may send buffer status for the bearers in SL BSR. Also, or alternatively, for indirect bearers, the WTRU may determine which BSR to send buffer status for flexible bearers (e.g., using the techniques described herein). For example, for flexible bearers (e.g., bearers configured to be able to send data over both paths) the WTRU may send buffer status in a Uu BSR (e.g., only a Uu BSR) and/or in an SL BSR (e.g., only and SL BSR). Also, or alternatively, the WTRU may determine whether to send buffer status in Uu BSR or SL BSR based on one or more conditions, as described herein. For example, if the primary path of the flexible bearer is the Uu, the buffer status may be sent to the Uu BSR. If the primary path of the flexible bearer is not the Uu, the buffer status may be sent to the SL BSR.

A WTRU may prioritize a SL BSR and/or a Uu BSR for multipath. One or more of the following may apply. For example, a remote WTRU may prioritize an SL BSR over Uu BSR (e.g., transmit the SL BSR on a first grant and the Uu BSR on a second, subsequent grant) based on whether SL BSR includes data from a flexible bearer.

A remote WTRU in multipath may be configured in mode 1 for SL transmissions. The remote WTRU may be configured with at least one Uu bearer that is sent over the direct (Uu) path, at least one Uu bearer that is sent over the indirect (e.g., relayed) path, and/or at least one Uu bearer that is sent over the direct and the indirect path. If data arrives at the WTRU for UL transmission on a bearer on the direct path, the remote WTRU may report the buffer status for the data in a Uu BSR. If data arrives at the WTRU for UL transmission on a bearer on the indirect path, the WTRU may report the buffer status for the data in a SL BSR. If data arrives at the WTRU for UL transmissions on a bearer on both paths, the remote WTRU may report buffer status to the BSR (e.g., Uu or SL) based on the configured primary path. The remote WTRU may determine the priority of the SL LCH to report in the prioritized SL BSR. For example, the remote WTRU may determine to prioritize the SL LCH if the SL LCH corresponding to a bearer on the indirect path has a priority larger than a threshold. Also, or alternatively, the remote WTRU may determine to prioritize the SL LCH if the SL LCH corresponds to a bearer on both paths (e.g., direct and indirect paths) and/or the Uu LCH priority associated with the bearer is higher than the highest Uu LCH priority in the Uu BSR. If the WTRU determines to prioritize the SL BSR, it may be included in the prioritized SL BSR in the grant (e.g., a grant before the Uu BSR).

A priority order of the SL BSR may depend on the presence of the buffer status from a flexible bearer. In certain scenarios, a WTRU may determine the priority order of the SL BSR based on the presence of a buffer status from the flexible bearer. If a WTRU has buffer status from indirect bearer (e.g., only an indirect bearer) to be reported, the SL BSR may be prioritized based on other (e.g., legacy) rules. The WTRU may determine whether to prioritize a SL LCH based on whether the SL LCH priority is above a threshold and (e.g., at the same time) other pending Uu LCH priority included in a (e.g., any) Uu BSR is below a threshold. If the SL LCH priority is above the threshold and other pending Uu LCH priority included in a (e.g., any) Uu BSR is below the threshold, the SL LCH may be prioritized and the WTRU may include the buffer status in a prioritized SL BSR. For example, the SL BSR may be included in a first grant (e.g., a grant that is before the Uu BSR and the SL BSR). Also, or alternatively, the (e.g., any) SL LCHs with buffer status to report that are associated with an SL LCH priority that is not higher than the threshold may be included into the SL BSR.

In certain scenarios, a SL BSR that includes data from a flexible bearer may be prioritized using a certain criteria. For example, the criteria may consider whether the flexible bearer is able to have the SL LCH priority and/or the Uu LCH priority configured.

In certain scenarios, the buffer status associated with a flexible bearer may be treated as Uu data having a priority assigned to the Uu LCH of the flexible bearer, where its priority may be compared to the priority of the Uu BSR. For example, the WTRU may include the buffer status for a SL LCH associated with a flexible bearer in the prioritized SL BSR if the Uu priority of the Uu LCH associated with the flexible bearer is higher that the priority of any Uu LCH reported in a pending Uu BSR.

In certain scenarios, the buffer status associated with a flexible bearer may be treated as Uu data and compared with the Uu threshold associated with UL/SL prioritization. For example, the WTRU may include the buffer status for a SL LCH associated with a flexible bearer in the prioritized SL BSR if the Uu priority of the Uu LCH associated with the flexible bearer is higher than the Uu priority threshold (e.g., which may be configured for UL/SL prioritization).

In certain scenarios, the priority of the SL LCH and Uu LCH of the flexible bearer may be considered. For example, the priority of the SL LCH and Uu LCH of the flexible bearer may be compared to the Uu threshold and SL threshold configured for UL/SL prioritization. In certain scenarios, the buffer status associated with a flexible bearer may be included in the prioritized SL BSR. For example, if the Uu priority of the Uu LCH associated with the flexible bearer is higher than the Uu priority threshold and/or if the SL LCH associated with the flexible bearer is higher that the SL priority threshold the buffer status associated with a flexible bearer may be included in the prioritized SL BSR.

In certain scenarios, the SL priority or Uu priority may depend on the primary path and/or another (e.g., similar) network configuration. For example, the WTRU may include the buffer status of the flexible bearer (e.g., a flexible bearer having Uu as the primary path) in the prioritized SL BSR if the Uu priority of the Uu LCH associated with the flexible bearer is higher than the Uu priority threshold. Also, or alternatively, the WTRU may include the buffer status of the flexible bearer (e.g., a flexible bearer having SL as the primary path) in the prioritized SL BSR if the SL priority of the SL LCH is higher than the SL priority threshold.

The priority order of a Uu BSR may depend on the presence of buffer status from flexible bearer. For example, prioritization of the Uu BSR may be changed/updated based on the presence of buffer status from a flexible bearer. In certain scenarios, for example, the WTRU may include buffer status from the flexible bearer into Uu BSR based on network configuration (e.g. the primary path).

In certain scenarios, the Uu BSR may be transmitted (e.g., may always be transmitted) with a higher priority than the prioritized SL BSR if, for example, the Uu BSR includes a buffer status associated with a flexible bearer.

In certain scenarios, the Uu BSR may be prioritized over the SL BSR. For example, the Uu BSR may be prioritized over the SL BSR if the Uu BSR includes a buffer status associated with the flexible bearer and/or the SL LCH priority associated with the flexible bearer is higher than the SL priority threshold for UL/SL prioritization. For example, the Uu BSR may be prioritized over the SL BSR if the Uu BSR includes a buffer status associated with the flexible bearer and/or the UL LCH priority associated with the flexible bearer is higher than the UL priority threshold for UL/SL prioritization. For example, the Uu BSR may be prioritized over the SL BSR if the Uu BSR includes a buffer status associated with the flexible bearer and/or the UL LCH priority associated with the flexible bearer is higher than any other UL priority being reported in the UL BSR.

Other factors may also, or alternatively, be used to determine the prioritization order of Uu BSR and SL BSR. For example, in addition to the presence of buffer status from a flexible BSR in the Uu BSR and/or the SL BSR, any additional conditions may further affect the prioritization order between the Uu BSR and the SL BSR. For example, the WTRU may (e.g., based on one or more of the conditions described herein) determine the appropriate mechanism for handling SL and Uu BSR based on the presence of multipath handling. The WTRU may (e.g., based on a factor) determine whether to use a first condition (e.g., UL threshold, SL threshold, direct priority comparison, etc.) or another condition to determine how to perform prioritization.

For example, the WTRU may determine the prioritization order of Uu BSR and SL BSR based on whether the cell of the direct path and the relayed path are the same and/or are associated with the same cell group. For example, the WTRU may determine the prioritization order of Uu BSR and SL BSR based on whether the WTRUs are connected by SL interface or another interface. For example, the WTRU may determine the prioritization order of Uu BSR and SL BSR based on whether the amount of data being reported for a LCH is above or below a threshold. For example, the WTRU may determine the prioritization order of Uu BSR and SL BSR based on the QoS marking associated with any of the data being reported in the buffer status (e.g., if any of the data to be reported in the buffer status has a PSDB which is lower than a threshold). For example, the WTRU may determine the prioritization order of Uu BSR and SL BSR based on the number of L2 destination IDs or relay IDs to be included in the buffer status. For example, the WTRU may determine the prioritization order of Uu BSR and SL BSR based on whether the buffer status (e.g., all the buffer status) is able to be included in an UL grant. For example, the WTRU may determine the prioritization order of Uu BSR and SL BSR based on the type of BSR being reported in either case (e.g. truncated BSR, long BSR, periodic BSR, etc.).

The processes and instrumentalities described herein may apply in any combination, may apply to other wireless technologies, and for other services. A WTRU may refer to an identity of the physical device, or to the user's identity such as subscription related identities, e.g., MSISDN, SIP URI, etc. WTRU may refer to application-based identities (e.g., usernames that may be used per application).

The processes described above may be implemented in a computer program, software, and/or firmware incorporated in a computer-readable medium for execution by a computer and/or processor.

Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, UE, terminal, base station, RNC, and/or any host computer.

What is claimed is:

1. A wireless transmit receive unit (WTRU) comprising:
a processor and a memory, the processor and the memory configured to:
receive bearer configuration information, the bearer configuration information comprising at least one of:
a configuration for a first bearer that is associated with a direct path,
a configuration for a second bearer that is associated with an indirect path, and
a configuration for a third bearer that is associated with the direct path and the indirect path;
receive data via the first bearer and the third bearer;
generate a first Uu buffer status report (BSR) in response to data received via the first bearer;
generate a first sidelink (SL) BSR in response to data received via the third bearer;
determine a priority associated with the first SL BSR and a priority associated with the first Uu BSR, wherein the priority associated with the first SL BSR is greater than the priority associated with the first Uu BSR; and
send a transmission comprising the first SL BSR in a first uplink (UL) grant.

2. The WTRU of claim 1, wherein the transmission comprising the first SL BSR is sent on a primary path configured for the WTRU.

3. The WTRU of claim 1, wherein the processor and the memory are further configured to:
receive data via the second bearer;
generate a second SL BSR in response to the data received via the second bearer; and
determine a priority associated with the second SL BSR generated in response to the data received via the second bearer, wherein the priority associated with the first SL BSR and the priority associated with the second SL BSR are based on any of: a quality of service (QoS), an associated cell identifier (ID), a priority threshold, or an indication received in the configuration for the second bearer or in the configuration for the third bearer.

4. The WTRU claim 1, wherein the data received via the first bearer is associated with a first quality of service (QoS) and the data received via the third bearer is associated with a second QoS, and wherein the processor and the memory are further configured to determine the priority associated with the first SL BSR based on the first QoS or the second QoS.

5. The WTRU of claim 1, wherein the data received via the first bearer is associated with a first latency threshold and the data received via the third bearer is associated with a second latency threshold, and wherein the processor and the memory are further configured to determine the priority associated with the first SL BSR based on the first latency threshold or the second latency threshold.

6. The WTRU of claim 1, wherein the processor and the memory are further configured to send a second transmission comprising the first Uu BSR in a second UL grant, wherein the second UL grant is after the first UL grant.

7. The WTRU of claim 1, wherein the processor and memory are further configured to determine the priority associated with the first SL BSR based on a first cell identifier (ID) associated with the direct path and a second cell ID associated with the indirect path.

8. The WTRU of claim 1, wherein the processor and memory are further configured to:
receive data via the second bearer;
generate a second SL BSR in response to the data received via the second bearer; and
determine a prioritized SL logical control channel (LCH) to report the second SL BSR, wherein the SL LCH is determined to be prioritized based on a priority associated with the second SL BSR corresponding being larger than a threshold.

9. The WTRU of claim 1, wherein the processor and memory are further configured to:
generate a second Uu BSR in response to the data received via the third bearer;
determine a priority associated with the second Uu BSR generated in response to the data received via the third bearer, wherein the priority associated with the second Uu BSR generated in response to the data received via the third bearer is greater than the priority associated with the first Uu BSR generated in response to the data received via the first bearer; and
determine a prioritized SL LCH to report the first SL BSR, wherein the SL LCH is determined to be prioritized based on the priority associated with the second Uu BSR generated in response to the data received via the third bearer being higher than the priority associated with the first Uu BSR generated in response to the data received via the first bearer.

10. The WTRU of claim 1, wherein the WTRU is a remote WTRU configured in multipath mode 1 for SL transmissions.

11. A method performed by a wireless transmit receive unit (WTRU) comprising:
receiving bearer configuration information, the bearer configuration information comprising at least one of:
a configuration for a first bearer that is associated with a direct path,
a configuration for a second bearer that is associated with an indirect path, and
a configuration for a third bearer that is associated with the direct path and the indirect path;
receiving data via the first bearer and the third bearer;
generating a first Uu buffer status report (BSR) in response to data received via the first bearer;
generating a first sidelink (SL) BSR in response to data received via the third bearer;
determining a priority associated with the first SL BSR and a priority associated with the first Uu BSR, wherein the priority associated with the first SL BSR is greater than the priority associated with the first Uu BSR; and
sending a transmission comprising the first SL BSR in a first uplink (UL) grant.

12. The method of claim 11, wherein the transmission comprising the first SL BSR is sent on a primary path configured for the WTRU.

13. The method of claim 11, further comprising:
receiving data via the second bearer;
generating a second SL BSR in response to the data received via the second bearer; and
determining a priority associated with the second SL BSR generated in response to the data received via the second bearer, wherein the priority associated with the first SL BSR and the priority associated with the second SL BSR are based on any of: a quality of service (QoS), an associated cell identifier (ID), a priority threshold, or an indication received in the configuration for the second bearer or in the configuration for the third bearer.

14. The method of claim 11, wherein the data received via the first bearer is associated with a first quality of service (QoS) and the data received via the third bearer is associated with a second QoS, and wherein the processor and the memory are further configured to determine the priority associated with the first SL BSR based on the first QoS or the second QoS.

15. The method of claim 11 wherein the data received via the first bearer is associated with a first latency threshold and the data received via the third bearer is associated with a second latency threshold, and wherein the processor and the memory are further configured to determine the priority associated with the first SL BSR based on the first latency threshold or the second latency threshold.

16. The method of claim 11 to 15, further comprising sending a second transmission comprising the first Uu BSR in a second UL grant, wherein the second UL grant is after the first UL grant.

17. The method of claim 11, further comprising determining the priority associated with the first SL BSR based on a first cell identifier (ID) associated with the direct path and a second cell ID associated with the indirect path.

18. The method of claim 11, further comprising:
receiving data via the second bearer;
generating a second SL BSR in response to the data received via the second bearer; and
determining a prioritized SL logical control channel (LCH) to report the second SL BSR, wherein the SL LCH is determined to be prioritized based on a priority associated with the second SL BSR being larger than a threshold.

19. The method of claim 11, further comprising:
generating a second Uu BSR in response to the data received via the third bearer;
determining a priority associated with the second Uu BSR generated in response to the data received via the third bearer, wherein the priority associated with the second Uu BSR generated in response to the data received via the third bearer is greater than the priority associated with the first Uu BSR generated in response to the data received via the first bearer; and
determining a prioritized SL LCH to report the first SL BSR, wherein the SL LCH is determined to be prioritized based on the priority associated with the second Uu BSR generated in response to the data received via the third bearer being higher than the priority associated with the first Uu BSR generated in response to the data received via the first bearer.

20. The method of claim 11, wherein the WTRU is a remote WTRU configured in multipath mode 1 for SL transmissions.
